(19) United States
(12) Patent Application Publication
(10) Pub. No.: US 2008/0297503 A1
(43) Pub. Date: Dec. 4, 2008

(54) System and method for reconstructing a 3D solid model from a 2D line drawing

(76) Inventors: John Dickinson, London (CA); Yong Zeng, Pointe-Claire (CA); Zhenheng Li, Aiken, SC (US); Michael Kernahan, London (CA); Alfred Sham, London (CA); Ajit Pardasani, London (CA)

Correspondence Address: CASSAN MACLEAN, 307 GILMOUR STREET, OTTAWA, ON, K2P 0P7, CA

(21) Appl. No.: 11/806,093

(22) Filed: May 30, 2007

(51) Int. Cl. G06T 17/00

(52) U.S. Cl. 345/420

(57) ABSTRACT

A system and method for reconstructing a 3D solid model from a 2D axonometric projection (line drawing) are described herein. The system comprises an interactive face identification module for identifying candidate 2D boundary loops for a user to selectively verify as corresponding to valid faces in the 3D solid model. The system further comprises an interactive geometry reconstruction module for reconstructing the 3D solid model from the 2D line drawing and validated boundary loops by iteratively receiving constraints from a user and propagating such constraints to the elements of the model following ranking rules to preserve significant symmetrical characteristics of the 3D solid.

### FIELD OF THE INVENTION

The invention relates generally to computer-aided design and more particularly to 3D geometry reconstruction.

### BACKGROUND OF THE INVENTION

In the earliest stages of design, the drawing tools of choice for most mechanical engineers are paper and pencil. These tools are easy to use and support all the fundamental activities that occur during the early stages of design: capturing design concepts and variations; annotations; and storyboarding. Designers generally sketch new product concepts on paper and rely on computer aided design (hereinafter “CAD”) system operators to interpret and transfer these designs to CAD systems. This process requires not only extra time, but can also add substantial delays due to inaccuracies in interpretation.

Though current CAD systems are more powerful and flexible than pencil and paper as drafting applications, they are nevertheless ill suited for use during conceptual design. They do not support the free flowing generation and recordation of ideas. Their interaction paradigms are heavily biased toward requiring complete information and hence require designers to determine the complete sequence of modeling operations before beginning to create the design. For many designers with no firm dimensions yet in mind, sketching a concept shape is faster and results in an approximate representation more in keeping with the level of certainty available at an early stage in the design without the cognitive load associated with modelling operations in CAD.

Axonometric projection is typically employed by designers for sketching technical drawings because it is a simple technique, retains much of the accuracy of the original and requires minimal artistic skill. A considerable time and effort savings would be realized, therefore, if designers were able to create 2D axonometric sketches, annotate and edit them, and subsequently transfer them to a CAD system. This would further eliminate the need for maintaining paper records of sketches and notes.

It is desirable, therefore, to be able to reconstruct a 3D solid model as is typically provided in a CAD system from a 2D line drawing representing a 2D axonometric projection of the solid. Such a reconstruction is highly complex, however, as it entails determining a depth component for each point in the 2D line drawing. The problem is illustrated in FIG. 1. In the forward projection transformation, the mapping f from point Pᵢ(xᵢ,yᵢ,zᵢ) in 3D space to point Pᵢ′(xᵢ′,yᵢ′) in 2D space is deterministic. Similarly, inferring 2D topology from 3D topology is also deterministic. The reverse mapping f′ from Pᵢ′ to Pᵢ—i.e. determining the 3D geometry from a 2D projection—is known as the reverse projection.

The reverse projection problem is illustrated in FIG. 2 which shows a 2D axonometric projection Pᵢ′(xᵢ′,yᵢ′) of a point Pᵢ(xᵢ,yᵢ,zᵢ) in 3D space. It is assumed that both 2D spaces and 3D spaces have a common coordinate system and each 3D point is projected to 2D along a direction that is determined by the projection vector \hat{r}(α,β,γ) of unit length. The figure shows a particular case where the projection is made on the xy plane. However, in general, projections can also be made on xz and yz planes. In general, if Pᵢ(xᵢ,yᵢ,zᵢ) and Pᵢ′(xᵢ′,yᵢ) are known, then all three components of the projection vector can be obtained. In the special case where the x and y coordinates of all 3D and 2D points are the same (i.e. xᵢ=xᵢ′ and yᵢ=yᵢ′ for all i) the projection vector will simply be (0,0,-1). This special case poses a less difficult problem than the general case.

Once the projection vector \hat{r} is known, the zᵢ coordinate remains to be determined for each point Pᵢ. It can be seen from FIG. 2 that any number of points Pᵢ in the direction of projection vector \hat{r} will lead to the same projection point Pᵢ′ in 2D. Hence, the precise reconstruction of each projected point requires the projection vector \hat{r} and one further constraint that will determine how far along \hat{r} the reconstructed point Pᵢ is from the projection point Pᵢ′; determining this quantity further provides the remaining unknown component of the reconstructed point Pᵢ, namely zᵢ. The reconstruction of a 3D solid with n vertices from the counterpart 2D projection accordingly has n unknowns. Therefore, n equations are needed to determine the remaining zᵢ components, and these equations must be derived from further constraints which provide the relationship between the 3D geometry and the 2D geometry.

A determination of the reverse mapping f′, while plausible, is an NP-complete problem as no efficient process has been found. NP (“non-deterministic polynomial time”)-complete problems are hard problems that require times that are exponential functions of the problem size. The problem is frustrated by the fact that typical hand-drawn line drawings contain inaccuracies flowing from the inherent limitations of hand-drawing.

There is a need, therefore, for a system and method for reconstructing a 3D solid model from a 2D axonometric projection which has process for determining the 3D geometry of the model from the 2D geometry of the projection and such constraints as are required, and a convenient means for providing the required constraints.

### BRIEF SUMMARY OF THE INVENTION

Disclosed herein are systems and methods for reconstructing a 3D solid model from a 2D line drawing which overcome the disadvantages of previous solutions. The systems and methods provide means to enable a user to easily and quickly generate 3D information constituting a 3D solid model from a 2D line drawing and geometrical constraints supplied by the user. In this way, initial conceptual drawings may easily and quickly be converted into a 3D solid model for use in the preparation of formal design drawings.

The invention is found in a method of reconstructing a 3D solid model from a 2D line drawing as described hereinafter. The 3D solid model includes a plurality of elements including a plurality of faces. In the method, a plurality of boundary edge loops in the 2D line drawing is interactively determined. Each such boundary edge loop is a 2D projection of a corresponding one of the faces in the 3D solid model. 3D information of the elements of the 3D solid model is then interactively determined from the boundary edge loops and a plurality of user-supplied constraints. The determination of the 3D information of the elements of the 3D solid model accomplishes the reconstruction of the 3D solid model.

### BRIEF DESCRIPTION OF THE DRAWINGS

An understanding of the exemplary embodiments will be obtained from the following description, with reference to the following drawings in which:

FIG. 1 shows a flow chart illustrating a mapping between a 2D point, a 3D point, 2D topology and 3D topology.

FIG. 2 shows a graph illustrating the projection of a 3D point to a 2D point.

FIG. 3 shows a system according to one embodiment which receives a 2D line drawing in the form of an input data file.

FIG. 3A shows a system according to another embodiment which directly receives raw sketches for conversion into a 2D line drawing.

FIG. 4 shows a module/component diagram illustrating a system according to another embodiment.

FIG. 4A shows a module/component diagram illustrating a system according to an embodiment which directly receives raw sketches for conversion into a 2D line drawing.

FIG. 4B shows a flowchart illustrating a method for converting raw sketches into a 2D line drawing.

FIG. 5 shows a flowchart illustrating a method executed by the candidate boundary edge loops identification component of the system illustrated in FIG. 4.

FIG. 6 shows a flowchart illustrating a method executed by the interactive boundary edge loop validation component of the system illustrated in FIG. 4.

FIGS. 7A and 7B show graphs illustrating the subdivision of a graph as performed by a variant of the interactive face identification module of the system illustrated in FIG. 4.

FIG. 8 shows a flowchart illustrating a method executed by the interactive constraint application component of the system illustrated in FIG. 4.

FIG. 9 shows a flowchart illustrating a method of propagating results as performed by a variant of the interactive geometry reconstruction module of the system illustrated in FIG. 4.

FIG. 10 shows a flowchart illustrating a method executed by the interactive linear formulation component of the system illustrated in FIG. 4.

Where appropriate, the same reference numerals are used in the drawings to indicate like features in all of the drawings.

### DETAILED DESCRIPTION OF EXEMPLARY EMBODIMENTS OF THE INVENTION

### Overview

A system for reconstructing a 3D solid model from a 2D axonometric projection, in the form of a 2D line drawing, is described herein. The system employs processes to deduce a subset of the constraints needed to perform the reconstruction from the known 3D and 2D geometry, and further provides means to enable a user to efficiently and conveniently provide the remaining constraints needed to complete the reconstruction.

The system may be any appropriate device or means capable of performing the processes and carrying-out the functions described herein and which has means for receiving data containing a 2D line drawing, means to carry out the processes and interactive functions for reconstructing a 3D solid model from the 2D line drawing as described herein, and means to create and store data containing the reconstructed 3D solid model.

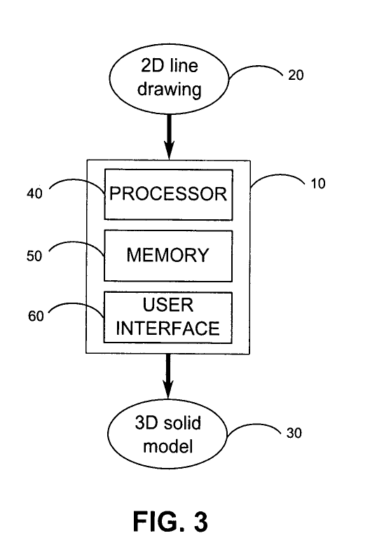

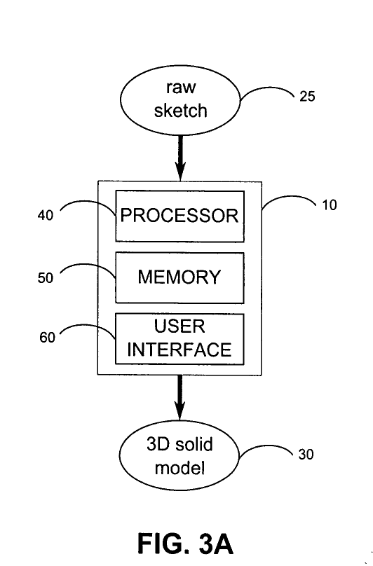

With reference to FIG. 3, in one embodiment, the system 10 comprises a computer configured to receive an input data file containing a 2D line drawing 20, to carry out the aforementioned processes and interactive functions, and to provide an output data file containing the reconstructed 3D solid model 30. The computer has a processor 40, a memory 50, and a user interface 60. In one embodiment, the system 10 receives the 2D line drawing 20 from a peripheral storage medium, in which case the computer further has a corresponding reader; in a second embodiment, the system 10 receives the 2D line drawing 20 from a network connection such as a connection to a local area network or the Internet. The user interface 60 may be any appropriate means for the system to display to a user the 2D line drawing 20 and 3D solid model 30 as it is being reconstructed, and for the user to enter information into the system 10 to supply constraints or otherwise in the reconstruction process. Where the system 10 comprises a computer, such user interface means includes, in one embodiment, a display (e.g. a monitor) and input devices (e.g. a keyboard, pointing device or tablet) operatively connected to the computer.

The input data file may encode the 2D line drawing 20 in any suitable format. In one embodiment, the 2D line drawing 20 represents a 2D vertex-edge graph corresponding to an isometric engineering drawing of a valid 3D object. The system 10 in other embodiments receives 2D line drawings 20 in other suitable formats known by skilled artisans.

The system 10 may alternatively have means to input directly, or to receive an input data file containing, a raw sketch 25, as illustrated in FIG. 3A, which is then converted and processed by the system 10 into the requisite 2D line drawing 20. In such a case, the system 10 has means for converting the raw sketch 25 into the requisite 2D line drawing 20 including recognition processes to create a parameterized representation of the raw sketch 25. Such recognition processes may incorporate adjustable parameters in order to better suit a particular user's drawing habits.

The system 10 may have any suitable means for receiving a raw sketch 25. In one embodiment, the system 10 has means for capturing pen strokes, called raw or freehand strokes, which are then converted into entities such as symbols and edges. Such input strokes may be captured using a tablet, a tablet PC, a portable computing and communications device similar to a pocket PC and cellular telephone, or any other device for vector drawing or freehand sketching. Alternatively, the system may comprise means to perform 2D line and arc recognition to convert a scanned image of a line drawing into the requisite 2D line drawing 20 input data file.

The system 10 may additionally comprise means for performing any pre-processing functions known in the art. For example, the system 10 may comprise means for filtering and reducing noise in a raw sketch 25, or means for fitting segmented strokes to straight lines and elliptical arcs.

The output data file may also encode the 3D solid model 30 in any suitable format. In general, a 3D solid model has a number of basic entities including vertices, edges, faces and constraints relating the other entities. In one embodiment, the 3D solid model provides classes of entities with each entity containing functionality related to the class for carrying out the processes and functions described hereinafter; these elements have logic associated with their classes that provides functionality for the reconstruction process. One embodiment comprising such entities includes: a basic entity from which the remaining entities are derived; vertices; straight edges; curved edges; faces; planar faces; curved faces; and constraints.

In a further embodiment, both the 2D data and the 3D data representing the 2D line drawing and 3D solid model, respectively, are stored in a single data structure. In this case, the 2D data may comprise a subset of the 3D model.

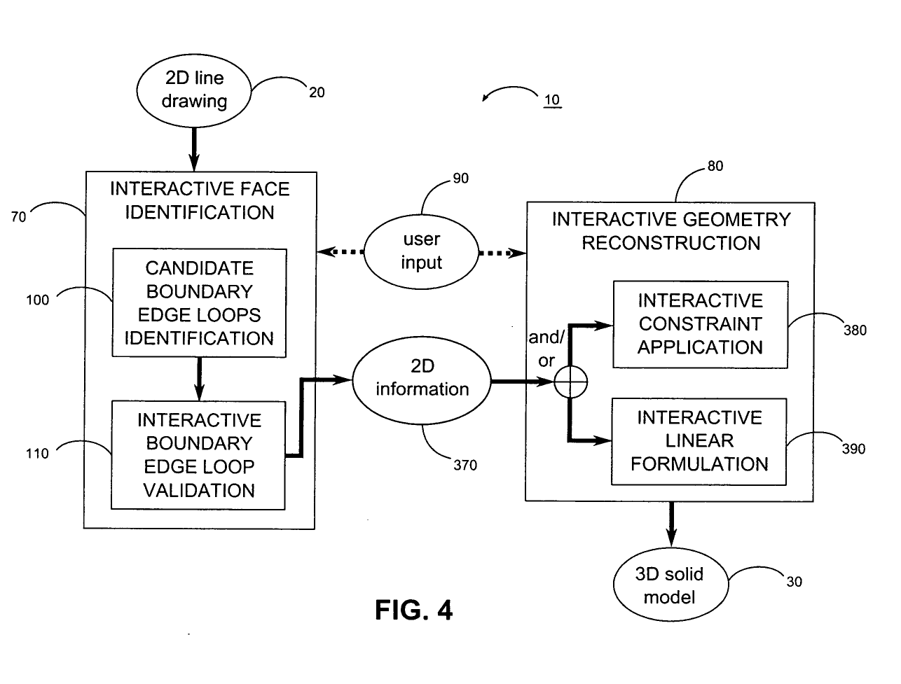

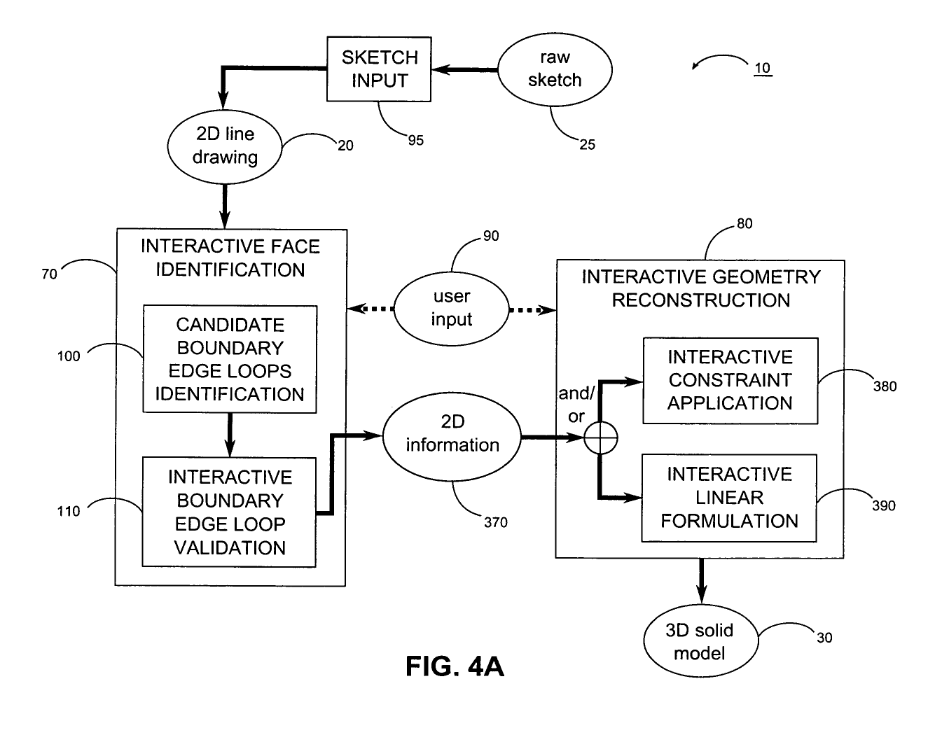

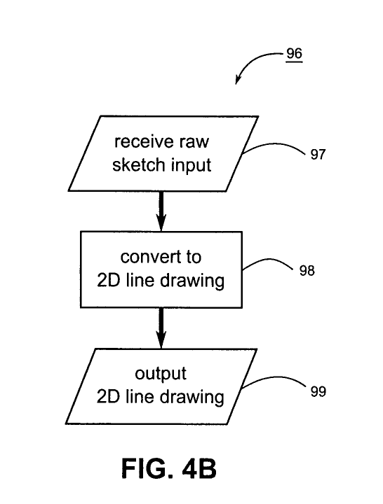

With reference to FIG. 4, in another aspect of the invention the system 10 comprises an interactive face identification module 70 and an interactive geometry reconstruction module 80 which are described in greater detail hereinafter. The system 10 is configured to carry out the reconstruction in two stages. In a first stage, the interactive face identification module 70 receives as input a 2D line drawing 20 and interactively receives user input 90 identifying the boundary loops in 2D geometry which correspond to valid faces in 3D geometry. In a second stage, the interactive geometry reconstruction module 80 interactively receives further user input 90 identifying relationships between the constituent elements of the model. The user input 90 in the two stages together provides the remaining constraints needed by the system 10 to complete the reconstruction of the 3D solid model 30 from the 2D line drawing 20.

In embodiments where the system 10 receives a raw sketch 25 which is then converted into the requisite 2D line drawing 20, the system 10 further comprises a sketch input module 95 as illustrated in FIG. 4A. With reference to FIG. 4B, the sketch input module 95 performs a sketch input process 96 wherein the sketch input module 95 receives raw sketch input (step 97) from a user, converts it into a 2D line drawing (step 98) by any of the means described above, and outputs the 2D line drawing (step 99). In the conversion step 98, the sketch input module 95 carries out the recognition processes described above (including the incorporation of any adjustable parameters) and in some embodiments performs any selection of the pre-processing functions described above.

The step of receiving raw sketch input 97 may provide functions for a user to directly enter the raw sketch 25 into the system 10. In one embodiment, the sketch input module 95 provides functions for the user to do any of the following: draw freehand sketches or 2D line drawings on multiple layers; organize and manage such layers; edit freehand sketches through any suitable operations including select, copy, paste, and pen erase; edit 2D line drawings through any suitable operations including select, trim, delete, cut, copy and paste; and undo and redo any operations to recover from errors.

### Interactive Face Identification—Overview

With reference to FIG. 4, the system 10 has an interactive face identification module 70 whose function is to determine all boundary edge loops in the 2D line drawing 20 that are 2D projections of existing faces of the 3D solid. The input to the interactive face identification module 70 is a 2D vertex-edge line drawing 20 corresponding to an isometric engineering drawing of a valid 3D solid model. The output of said module is a set of 2D information 370 including elements of the 2D line drawing (e.g. lines, vertices) as well as validated boundary edge loops which have been determined by the interactive face identification module 70 to correspond to the perimeter edges of surfaces of the 3D solid model 30.

There is uncertainty in determining valid boundary edge loops that are isometric projections of the real faces of a 3D solid model: since the projection from a 3D object to a 2D drawing is many-to-one, there is more than one reverse mapping from the 2D drawing to the 3D object. Accordingly, it is possible for some reverse mappings to incorrectly indicate that a loop is a valid boundary edge loop which corresponds to a face. The system solves this problem by providing means to enable a user to identify valid boundary edge loops.

Accordingly, the interactive face identification module 70 has two components. The first component is a candidate boundary edge loops identification component 100 for identifying all candidate boundary edge loops that potentially correspond to faces. The second component is an interactive boundary edge validation component 110 for interactively receiving user input 90 to enable a user to validate those candidate boundary edge loops which are considered to correspond to faces; the user thereby identifies boundary edge loops which define the perimeters of faces of the 3D solid and rejects those that do not. The two components are described in greater detail hereinafter.

### Interactive Face Identification—Candidate Boundary Edge Loops Identification

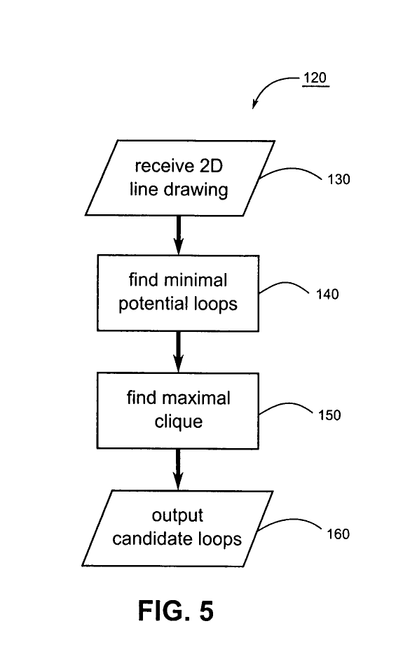

The first component of the interactive face identification module 70 is the candidate boundary edge loops identification component 100. With reference to FIG. 5, this first component executes a corresponding process 120 for identifying candidate boundary edge loops. In the process 120, a 2D line drawing comprising a vertex edge graph corresponding to a 2D isometric line drawing is received (step 130), and the minimal boundary edge loops that have the potential to be faces are found using a depth-first search process (step 140). A boundary edge loop is considered to have the potential to be a face if it is a closed loop of non-self-intersecting edges wherein there is no edge in the graph that connects two non-adjacent vertices in the loop. Any appropriate process for finding boundary edge loops which satisfies these constraints may be employed. For example, the process described in Liu, J. and Lee, Y., “A graph-based method for face identification from a single 2D line drawing”, IEEE, Transactions on pattern analysis and machine intelligence, Vol. 23, No. 10, pp. 1106-1119 or Shpitalni, M. and Lipson, H., “Identification of faces in a 2D line drawing projection of a wire-frame object”, IEEE, Transactions on pattern analysis and machine intelligence, Vol. 18, No. 10, pp. 1000-1012 may be used for this purpose. Adaptations of such processes, including that described by Liu and Lee, may also be employed, including dividing such processes into consecutive procedures, or employing object-oriented techniques such as method overloading.

The maximal clique of the minimal potential loops is then determined (step 150) and a list of candidate loops is outputted (step 160). A clique of a graph is a complete sub-graph of the graph. The goal of finding the maximal clique is to find candidate boundary edge loops from the space of the potential loops using processes for finding maximal cliques from graph theory. By following such a process (e.g. as is provided in Liu and Lee, above), a new weighted graph is constructed by making use of the face adjacency theorem. The face adjacency theorem states that two faces can coexist in a 3D object if and only if their common edges are smooth. In particular, common edges are collinear if the two faces are planar and consist of straight edges. A new weighted vertex is constructed corresponding to a minimal potential face; the weight of the vertex is defined to be the number of edges of the face. There is an edge between two vertices if and only if the corresponding faces can coexist. Candidate loops that have the potential to be faces are then found by searching for all maximal weight cliques in the weighted graph using any suitable maximal weight clique finding process. For example, in one embodiment this function is performed by a modified form of the process described by Liu and Lee (above, at pp. 1113-1114 thereof. (Whereas the process described by Liu and Lee linearly orders the vertices of the weighted graph and then assigns a level to the adjacent vertices, the modified form recursively finds maximal cliques based on the levels thereby simplifying the process and making it easier to implement.)

The above-described process produces lists of candidate boundary edge loops from a line drawing by applying internal coherency rules to limit the number of loops that will be presented to the user for validation. There may be more than one such list depending upon the characteristics of the geometry of the line drawing. Each clique in the weighted graph corresponds to a list of candidate boundary edge loops. The lists of candidate boundary edge loops may include lists of candidate visible and occluded loops; the latter may further include lists of candidate partially and fully occluded loops.

The candidate loops outputted in step 160 are then passed to the second component of the module to be validated through user input, further described hereinafter.

### Interactive Face Identification—Interactive Boundary Edge Loop Validation

With reference to FIG. 4, the second component of the interactive face identification module 70 is the interactive boundary edge loop validation component 110. This component executes a process which receives user input 90 selecting valid boundary edge loops in the 2D line drawing 20 which are considered to correspond to faces in the 3D solid model.

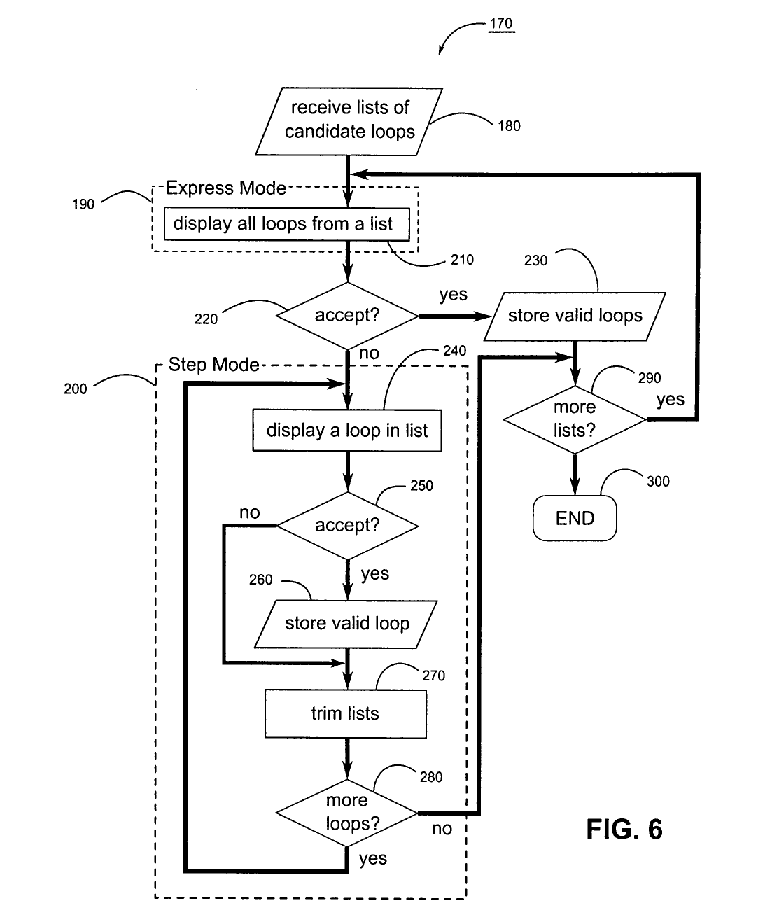

The second component process 170 is represented by the flowchart shown in FIG. 6. The process receives lists of candidate loops (step 180) generated by the first component as described above. Such lists may include a number of lists of loops which are fully visible, which are partially occluded and which are fully occluded. In one embodiment of the second component, the fully visible loops are validated first followed by the occluded loops.

The purpose of boundary edge loop validation is to find an optimal set of loops that correspond to the valid faces of the 3D solid model employing information provided by a user. The process has two modes: an Express Mode 190 and a Step Mode 200 which will be described further hereinafter. In each mode the user is presented with candidate loops for validation and the means to validate loops corresponding to faces.

In Express Mode 190, the system displays (e.g. highlights) all loops from a list (step 210) to be validated. If all of the loops in the list so highlighted are considered to be valid, the user may accept them all (step 220) in which case they are stored (step 230) as valid loops in the 3D solid model. If at least one loop is not considered to be valid, the user may reject the list and the process will automatically switch to Step Mode 200.

In Step Mode 200, the system goes through each loop in the list one at a time; the region corresponding to the current loop is displayed (e.g. highlighted) (step 240). If the loop so displayed is considered to be valid, the user may accept it (step 250) in which case it is stored (step 260) in the database of valid loops in the 3D solid model. In either case, the system will trim the remaining lists of candidate loops (step 270) if there is more than one list remaining. When the user validates a loop, the system trims the lists of candidate loops by deleting any list which does not contain the validated loop; if a user rejects a candidate loop, the system deletes those lists containing the invalid loop. If only one list of candidate loops remains, the system will merely store valid loops (step 260) and ignore invalid loops. If there are further loops in the list to be validated (step 280) the Step Mode 200 routine repeats for each loop until there are no further loops in the list. The system then exits Step Mode 200.

After the completion of either Express Mode 190 or Step Mode 200, the system checks whether there are further lists of candidate loops to be validated (step 290); if there are lists remaining, the above-described process repeats for each such list. Otherwise, the process ends (step 300).

In a further embodiment of the system, the module provides for the manual removal by the user of previously validated boundary edge loops which are no longer considered to represent valid faces and, likewise, to identify as valid boundary edge loops which were previously rejected.

### Interactive Face Identification—Optional Sub-Region Processing

While the above-described interactive face identification module is effective in identifying all of the candidate boundary edge loops, it is somewhat computationally intensive. If the processing speed of the system executing the module is insufficient, the module may not be able to provide candidate boundary edge loops to the user in real time as is desirable. It is therefore desirable to incorporate into the module a method of dividing the computational volume into parts in order to enable the system to provide candidate boundary edge loops to the user for validation in real time on a part-by-part basis.

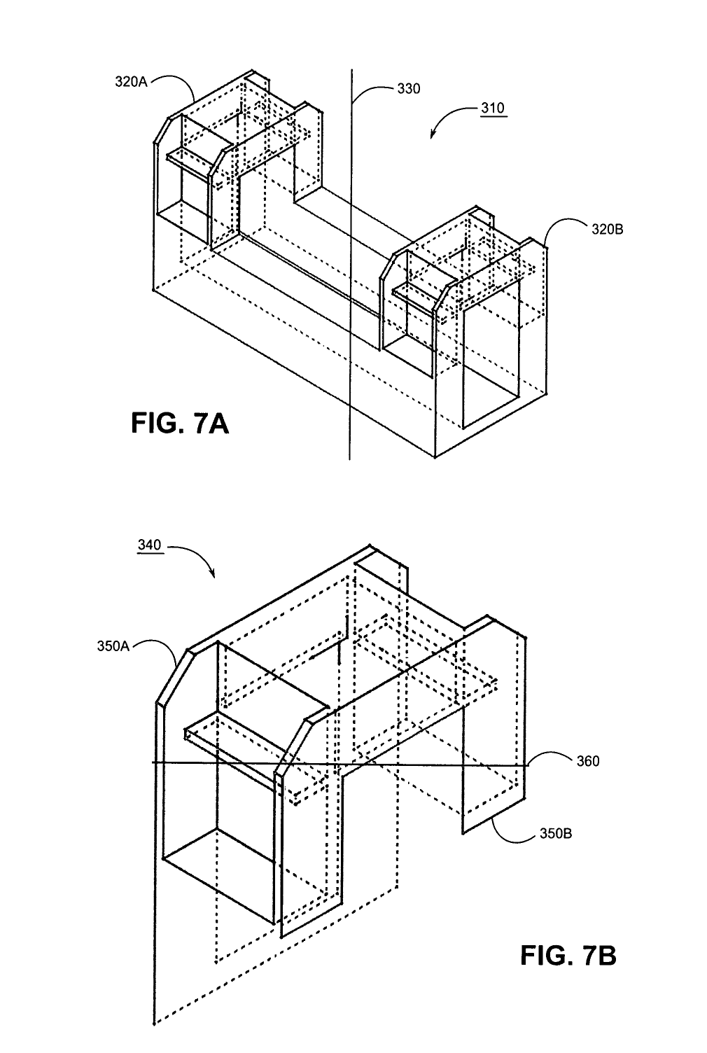

To this end, the system optionally subdivides the 2D line drawing into sub-regions representing parts of the eventual 3D solid model. The drawing may be divided on any convenient basis; in one embodiment of the system, the drawing is divided in sub-regions each containing about 50 edges, though any desired number of edges may be selected. With reference to FIG. 7A, a first drawing 310 to be so divided may be divided into sub-regions 320A, 320B by a vertical line 330, whereas, with reference to FIG. 7B, a second drawing 340 may be divided into sub-regions 350A, 350B by a horizontal line 360. If the number of edges in the drawing warrants, each sub-region may be further divided into sub-sub-regions, and so on, with the module operating recursively to process the entire drawing.

All such region-splitting occurs prior to the candidate boundary edge loops identification and interactive boundary edge loop validation processes described above. Each sub-region is then processed in order and presented to the user for validation. After each sub-region has been processed individually, the entire drawing is processed. Since most of the boundary edge loops will already have been validated or rejected by the user, a fraction of the total number of loops will remain, and the system will operate faster as a result. In particular, edges which have been cut in each division are not considered in the processing of the corresponding sub-region, but are instead considered during the processing of the larger sub-division containing the unbroken edge.

By splitting the drawing into sub-regions as described above, the user interface for the interactive face identification module will be better able to process and display candidate and validated boundary edge loops to the user in real time. With each acceptance or rejection of a candidate loop (and its corresponding face), the domain of edges that the system needs to parse is diminished. When the system returns to process each larger sub-region of the drawing, a greatly reduced number of edges remains to be processed. Rather than requiring a significant amount of time to process and display candidate boundary edge loops, the system responds in real time.

With reference to FIG. 4, the interactive face identification module 70 outputs a set of 2D information 370 including elements of the 2D line drawing (e.g. lines, vertices) and validated boundary edge loops determined by the above-described process to correspond to valid faces of the 3D solid model 30. The set of 2D information 370 is then received by interactive geometry reconstruction module 80 which inflates the 2D geometry of the 2D line drawing 20 to 3D geometry as is described in greater detail hereinafter.

### Interactive Geometry Reconstruction—Overview

With reference to FIG. 4, the system 10 has an interactive geometry reconstruction module 80 whose function is to reconstruct a 3D solid model 30 from 2D information 370 including elements of the 2D line drawing 20 (e.g. lines, vertices) and validated boundary edge loops, and further user input 90 comprising additional constraints. In the case of a manifold object, the 3D solid model 30 is a boundary-representation solid model; in the case of a non-manifold object, the model is a topologically connected but non-closed collection of surfaces. As described above, the 3D solid model generally has a number of basic entities including vertices, edges, boundary loops associated with faces and constraints relating the entities. In one embodiment, the 3D solid model provides classes of entities with each entity containing functionality related to the class for carrying out the processes and functions described hereinafter.

The interactive geometry reconstruction module 80 carries out the above-described function through one or both of two components: an interactive constraint application component 380 and an interactive linear formulation component 390. As is described in greater detail hereinafter, these two components may be used alternatively or in combination depending upon the nature of the 2D line drawing 20. More specifically, the interactive linear formulation component 390 may only be used when the 2D line drawing 20, or a portion thereof, is composed of straight lines only, whereas the interactive constraint application component 380 may be used for any 2D line drawing 20. The two components are described in turn hereinafter.

### Interactive Geometry Reconstruction—Interactive Constraint Application

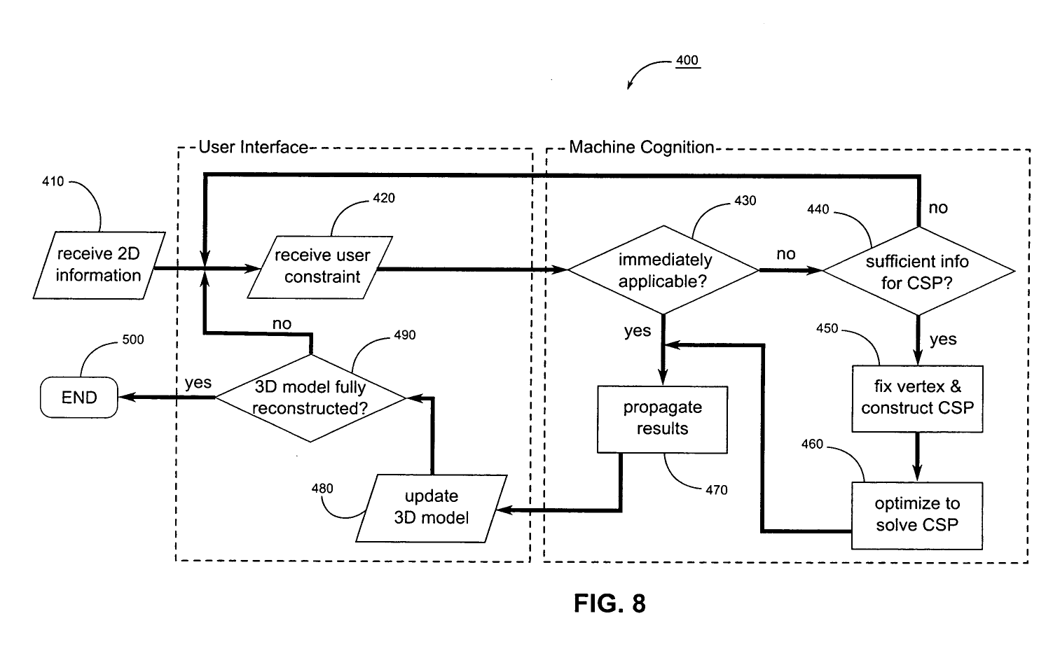

The interactive constraint application reconstruction process 400 carried out by the interactive constraint application component 380 is illustrated in FIG. 8. The system receives the 2D information (step 410) comprising elements of the 2D line drawing (e.g. lines, vertices) as well as the boundary edge loops previously validated as representing faces by the interactive face identification module 70. The interactive geometry reconstruction module 80 assumes that the faces are correctly identified, but does not necessarily expect the direction of the edges in the line drawings to be perfect. As described in greater detail hereinafter, the reconstruction process proceeds by iteratively receiving further constraints from the user and propagating them to all elements in the model in view of the topological connectivity of the elements; upon the provision of a constraint, each element is checked to determine whether its 3D information can be determined on the basis of known geometrical information including that of the neighbouring elements and the relating geometric equations.

Accordingly, the system receives a constraint (step 420) from a user via a user interface. If the system determines that the constraint is immediately applicable to the solution of the 3D component of a related element (decision 430), then the constraint is applied and propagated as far as possible to solve as many elements as possible (step 470). The propagation of constraints is described in greater detail hereinafter. The system determines whether a constraint is immediately applicable by applying any suitable logic which relates the geometrical properties of the constraint and of the element. For example, in one embodiment having a face angle constraint which defines the angle between two planar faces, the constraint is immediately applicable to determining the undetermined normal vector of one of the planar faces if the normal vector of the other planar face is known and the planar faces share a common edge. In this case, the constraint is immediately applied to determine the undetermined normal vector by rotating the known normal vector by the constraint face angle about the common edge. Any such geometrical relationships as are known in the art may be applied to the particular constraints to be applied.

Alternatively, if a sufficient number of constraints has been provided (decision 440), a vertex corresponding to the constraints may be fixed and a constraint satisfaction problem (hereinafter “CSP”) constructed (step 450), optimized and numerically solved using simple optimization processes (step 460). A CSP is formed as a minimization problem of the geometry of the corresponding elements wherein the goal is to minimize the sum of the squares of the residuals of the local constraints by adjusting the z term of the vertices related to the constraints. Thus, vertices adjacent a selected vertex are constructed based on optimization whereby the first part of the model gains 3D information and the remaining parts of the model are reconstructed in relation to these initial geometric entities.

The system may employ any constraints and CSPs as are appropriate for the geometry of the 2D line drawing and 3D solid model. In one embodiment, the constraints include: face angles, face coplanarity, planar face parallelism, relative length between straight edges, edge parallelism, edge to face perpendicularity, curved face coaxialism, planar surface and cylinder axis perpendicularity, and cylinder and edge parallelism. Residuals appropriate to each such constraint are calculated in solving the associated CSP.

If there are sufficient constraints for the construction and solution of a CSP, the result is propagated to the other elements (step 470). If there are insufficient constraints, a further constraint is received from the user (step 420). In either case, the 3D model is updated (step 480); a user display showing the model may also be thereby updated. If the 3D model has been fully reconstructed (step 490), then the process ends (step 500); otherwise, a further constraint is received from the user (step 420) and the process continues as described herein.

The model initially contains no constraints and all elements in the model initially have only 2D information. In order to reconstruct the 3D model from this 2D information it is preferable to first fix the z-coordinate of at least one vertex in order to prevent the model from sliding in space. An appropriate vertex to fix is one around which sufficient face angle or relative length constraints are provided to support the logical reconstruction of the 3D geometry of the neighbouring faces. If a vertex is at the apex of the intersection of n neighbouring planar faces, then sufficient information for forming a CSP is provided when at least n constraints are provided. These n constraints are preferably face angle constraints or relative length constraints wherein at least one is a face angle constraint. The process then executes iteratively, as described above, wherein further constraints are received from a user and propagated to the elements of the model until the 3D model has been fully reconstructed.

It is often possible to reconstruct the 3D model upon the provision of a few constraints which are propagated throughout the elements. If required, however, further constraints are received from the user and solved to generate further 3D geometry which in turn can be propagated across the model.

The reconstruction process may further comprise such additional steps as are appropriate for the 2D line drawing or 3D model. In one embodiment, following the provision by the user of a first constraint, the process further comprises separating construction lines from the 2D line drawing. In a further embodiment, the process comprises a further step of removing bihedral vertices in between collinear straight edges. (Bihedral vertices are those with only two edges connected to them and appear in drawings where an edge is partially occluded wherein the edge is drawn partially as a hidden edge and partially as a visible edge. Such vertices tend to cause distorted reconstruction of edges that should otherwise be straight.)

As will be described in greater detail hereinafter, the process may further comprise steps implicitly applying gestalt rules of interpretation to the model before attempting to propagate any determined 3D geometric information. In one embodiment, for example, gestalt rules are applied to account for our tendency to perceive linear parallelism. Where the model has a previously-fixed rectilinear corner having three “corner” edges radiating therefrom, a search is made for other “subject” edges that are nearly parallel (within e.g. 5 degrees) to one of the corner edges. Once gestalt linear parallelism constraints are added, the subject edges are sorted in order of length and, starting with the longest, the end points of the subject edges are iteratively adjusted in the 2D drawing to bring them more in line with the corresponding corner edges. Such adjustments are made by calculating the minimum shift of one end point of a subject line which is required the make the line parallel to the corresponding corner edge. These adjustments are repeated for each subject line in decreasing order of length, preferably for a predetermined number of iterations or until the total distance shifted by endpoints in one iteration is less that a predetermined value.

### Interactive Geometry Reconstruction—Propagation Process

As described above, the reconstruction process proceeds by iteratively receiving further constraints from the user and propagating them to all elements in the model in view of the topological connectivity of the elements and explicit rules about necessary properties of geometrical features (e.g. all edges and vertices lying on a planar face must satisfy the equation of the face). Each entity (e.g. vertex, straight/curved edge, constraint) has logic associated with it enabling the system to assess whether it can determine the 3D information of the element based on currently available 3D information and formulas associated with the element. Once the reconstruction has commenced with the calculation of the depths (i.e. z-value) of three or more vertices neighbouring a user-selected corner in the 2D drawing, the propagation process is then employed to ensure that all elements have sufficient information for the system to determine their 3D information.

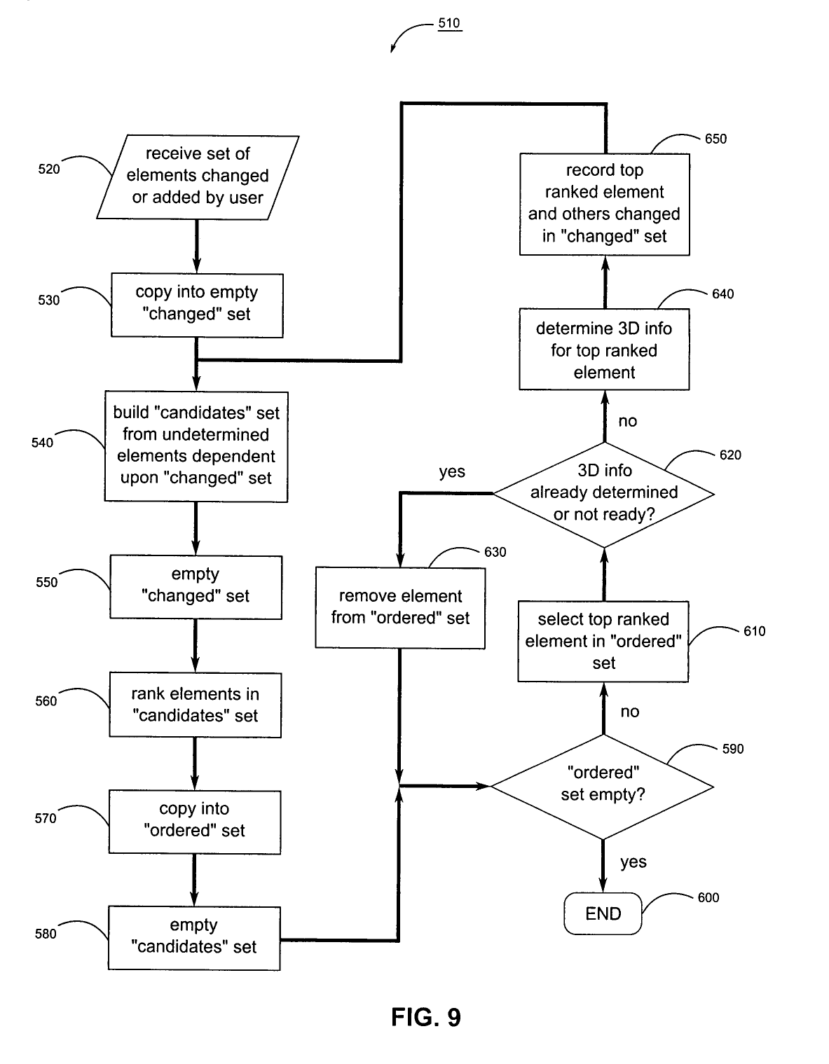

The propagation process 510 carried out by the system is illustrated in FIG. 9. The process receives a set of elements (step 520) which have been changed or added (e.g. a new constraint) by the user or through the initial step of reconstruction. This set of new or changed elements is first copied into an empty “changed” set (step 530). A new “candidates” set of elements which are currently undetermined and are dependent on the elements in the “changed” set is built (step 540). The “changed” set is then emptied (step 550). Each element in the “candidates” set is then assigned a ranking (step 560) and is copied into an “ordered” set (step 570) according to said ranking. The ranking process is discussed in greater detail hereinafter. If another element already exists in the list with the same ranking, the element is inserted with a slightly lower ranking. Any duplicate elements in the “ordered” set are discarded. The “candidates” set is then emptied (step 580). If the “ordered” set is empty (decision step 590) then the process is ended (step 600). Otherwise, the top ranked element in the “ordered” set is selected (step 610). If the 3D information has already been determined for the element, or if there are still insufficient constraints to determine the 3D information (decision 620) then the element is removed from the “ordered” set (step 630) and the next top ranked element is selected, if any (decision 590, step 610). Otherwise, the 3D information is determined for the top ranked element (step 640) and it and any other elements changed in the process are recorded in the “changed” set (step 650). A new “candidates” set is built and the process repeats.

In this manner, the elements in the 3D model are ranked and processed in a specific order according to their significance to the reconstruction process. The ranking process is described in greater detail hereinafter. Furthermore, every time the 3D information for an element is determined, other elements which are consequently affected are immediately ranked and added to the list for potential propagation.

### Interactive Geometry Reconstruction—Ranking Process

As described above, the propagation process is iteratively carried out on all changed elements and new elements added by a user wherein the elements are ranked in a specific order according to their significance to the reconstruction process. The ranking process is designed to preserve significant geometrical properties such as parallelism and flatness of planar faces, as well as any user defined constraints to be strictly enforced. To this end, a set of rules used in the ranking process is provided and is described in greater detail hereinafter.

The set of rules in the ranking process is specifically designed to take into account priorities naturally assigned by human cognition to various geometrical characteristics. Though humans can logically reason about geometry and understand that, for example, all edges and vertices bounding a planar face must lie on that face, what we really think about are things like “it should be flat”. The logical description of geometrical requirements in terms of formulas and geometrical relationships is the foundation of basic reconstruction processes, but rules about vertices and edges lying on faces, for example, do not necessarily capture other clues which may be termed gestalt in nature.

In particular, humans perceive certain familiar geometrical regularities first when viewing a sketch and these regularities are given precedence in our interpretation of the drawing thereby overriding inconsistencies that otherwise make the interpretation of the drawing more difficult. The rules in the ranking process attempt to heuristically capture some of these regularities and emphasize them during the reconstruction process. Such regularities may include, but are not limited to, the following:
face planarity;
skewed facial symmetry;
line parallelism;
line colinearity;
line orthogonality;
skewed face orthogonality;
line verticality;
isometry;
minimum standard deviation of angles;
corner orthogonality;
face perpendicularity; and
symmetry.
   Details of these regularities are discussed in the prior art, such as in P. Company, J.-M. Gomis and M. Contero (Dept. de Tecnologia, Jaume I Univ., Castellon, Spain), “Geometrical reconstruction from single line drawings using optimization-based approaches”, 7th International Conference in Central Europe on Computer Graphics, Visualization and Interactive Digital Media '99 (Plzen, Czech Republic: Univ. West Bohemia, 1999) 361-368. In particular, symmetry is an extremely important property upon which humans make many assumptions about geometry depicted in drawings.

Any appropriate rules which are directed to capturing and applying the importance of the aforementioned regularities may be employed in the system. In one embodiment, the rules include the following.

Constraints: These are generally provided by the user and are therefore given a high rank (e.g. 8). It is assumed that the user is best placed to determine the relative importance of the geometrical properties.

Vertices: These are also given a high rank (e.g. 8). Vertices with edges parallel to the principal directions are given an increase in rank (e.g. +1) per principal direction. An even greater increase (e.g. +2) is applied if the 3D information of all neighbouring faces of the vertex has been determined.

Planar Faces: A high rank (e.g. 9) is initially applied. The length of the projected (drawn) perimeter of the face is then calculated (peri) as well as the length of all edges on that perimeter that are parallel to the principal directions (primelen). The rank of the planar face is then increased by the calculated primelen/peri percentage. The rank is severely reduced (e.g. by −3*(peri-primelen)/peri) for faces with little or no perimeter parallel to the principal directions. A large increase (e.g. +3) is applied for faces neighbouring the initially fixed corner around which the reconstruction commenced. A further large increase (e.g. +2) is applied if two principal directions are determined for the face (whereas the cross product of the two directions (i.e. rays) gives the normal of the plane) and only a single vertex is required to complete the determination of the equations of the plane.

Straight Edges: A medium rank (e.g. 7) is assigned. The 3D information for straight edges is only determined if their endpoints are determined. User constraints may also likewise determine edges. However, they still should be checked periodically to see if their endpoints are determined as other entities may rely on them for their calculations.

Curved Faces: As these entities are best determined based on their neighbouring faces and edges, they are assigned a low rank. A rule similar to that for planar faces is used, but with a lower base ranking (e.g. 6). No increases are generally applied, though in another embodiment an increase is applied to cylinders that align with principal directions.

Curved Edges: As for curved faces, these entities are rarely drawn well and are best deduced from other elements in the drawing if possible. Accordingly, a low rank (e.g. 5) is assigned.

### Interactive Geometry Reconstruction—Interactive Linear Formulation

With reference to FIG. 4, and as described above, the interactive geometry reconstruction module 80 operates through one or both of two components: an interactive constraint application component 380 and an interactive linear formulation component 390. The latter is particularly useful in cases where the 2D line drawing consists of straight lines only. In such a case, the problem of the reconstruction of a 3D solid model from a 2D axonometric projection can be reduced to a linear problem when the user provides certain extra geometrical information. Such information is then used to infer the constraints that relate the length of projected edges to the length of corresponding 3D edges. The extra constraints reduce the 3D problem to a linear problem having a solution which can be found in a time that is a polynomial function of the size of the problem. The method is based on the principle that, if the actual size and shape of an object in 3D space is known, then relative comparison to its 2D projection will yield information on position, distance and orientation. The application of this principle helps to minimize the required user input by minimizing the number of constraints which must be provided by the user, and by minimizing the number of operations needed to define each of the constraints.

In such cases, the interactive linear formulation component 390 may be used in place of or in addition to the interactive constraint application component 380 described above. As with the interactive constraint application component 380, the interactive linear formulation component 390 receives, via a user interface, additional geometrical constraints needed for a solution of the reverse projection problem.

The linear problem to be solved by the interactive linear formulation component may be understood as follows. With reference to FIG. 2, the projection vector \hat{r} is a unit vector, and therefore:

α²+β²+γ²=1 (1)

The 3D point Pᵢ(xᵢ,yᵢ,zᵢ) and its corresponding 2D point Pᵢ′(xᵢ′,yᵢ) can be related by the equation:

\vec{OP}′ᵢ=\vec{OP}ᵢ+∥PᵢP′ᵢ∥\vec{r} (2)

Resolving this equation into vector components gives:

$$\{ \begin{matrix}{x}_{i}^{′} - {x}_{i} = α \sqrt{{( {x}_{i}^{′} - {x}_{i} )}^{2} + {( {y}_{i}^{′} - {y}_{i} )}^{2} + {( {z}_{i}^{′} - {z}_{i} )}^{2}} \\ {y}_{i}^{′} - {y}_{i} = β \sqrt{{( {x}_{i}^{′} - {x}_{i} )}^{2} + {( {y}_{i}^{′} - {y}_{i} )}^{2} + {( {z}_{i}^{′} - {z}_{i} )}^{2}} \\ {z}_{i}^{′} - {z}_{i} = γ \sqrt{{( {x}_{i}^{′} - {x}_{i} )}^{2} + {( {y}_{i}^{′} - {y}_{i} )}^{2} + {( {z}_{i}^{′} - {z}_{i} )}^{2}}\end{matrix} \qquad ( 3 )$$

In the special case where γ=0, the projection line is parallel to the xy plane: it projects either into the xz or yz plane. More generally, y≠0 and the projection vector projects the point Pᵢ onto the xy plane. In this case, z′ᵢ=0 and the equation can be simplified to:

$$\{ \begin{matrix}{x}_{i}^{′} - {x}_{i} = α \sqrt{{( {x}_{i}^{′} - {x}_{i} )}^{2} + {( {y}_{i}^{′} - {y}_{i} )}^{2} + {( {z}_{i} )}^{2}} \\ {y}_{i}^{′} - {y}_{i} = β \sqrt{{( {x}_{i}^{′} - {x}_{i} )}^{2} + {( {y}_{i}^{′} - {y}_{i} )}^{2} + {( {z}_{i} )}^{2}} \\ - {z}_{i} = γ \sqrt{{( {x}_{i}^{′} - {x}_{i} )}^{2} + {( {y}_{i}^{′} - {y}_{i} )}^{2} + {( {z}_{i} )}^{2}}\end{matrix} \qquad ( 4 )$$

Solving for x′ᵢ and y′ᵢ gives:

$$\{ \begin{matrix}{x}_{i}^{′} = {x}_{i} - \frac{α}{γ} {z}_{i} \\ {y}_{i}^{′} = {y}_{i} - \frac{β}{γ} {z}_{i}\end{matrix} \qquad ( 5 )$$

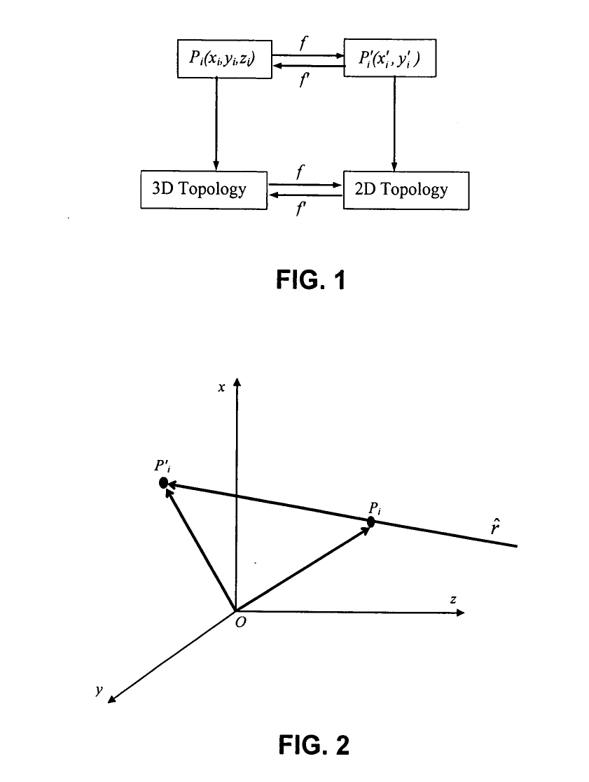

This equation defines the mapping from 3D space to the xy plane as shown by mapping f in FIG. 1. Once the projection vector is given and γ≠0, any point can be projected into the xy plane using the above equation. It should be noted that this equation is applicable only for projection from 3D space to 2D space and not vice versa, unless either xᵢ or yᵢ is already known and at the same time α≠0 and β≠0.

In view of the foregoing, the equations for the reverse projection from 2D to 3D space may be formulated as described hereinafter. It can be seen from FIG. 2 that any number of points in the direction of projection vector \hat{r}(α,β,γ) will lead to the same projection point in 2D. Hence, the precise reconstruction of each projected point requires the projection vector and a constraint that will determine the distance of the reconstructed point along the projection vector (e.g. in the z direction from the origin). In general, if Pᵢ(xᵢ,yᵢ,zᵢ) and Pᵢ′(xᵢ′,yᵢ′) of a point are known, then all three components of the projection vector can be determined. These two points along with Equation (1), above, provide three equations to solve for the three components of the projection vector (i.e. α, β and γ). In the special case that the x-y coordinates of all 3D and 2D points are the same (i.e. xᵢ=x′ᵢ and yᵢ=y′ᵢ for all i), the projection vector will be simply (0, 0, −1). It should be noted that this special case is less difficult to solve than the general case.

Once the projection vector is known, only one unknown remains (i.e. the z-coordinate) for each point to be reconstructed. Thus, one additional constraint is required for each point to be reconstructed. The purpose of this constraint is to fix how far the reconstructed point lies along the projection vector. For a solid with n vertices to be reconstructed, there are n unknowns. Therefore, n equations are needed to determine these variables. Such equations are derived from extra constraints which are provided by a user and provide the relationships between the 3D geometry and the projected 2D geometry. These constraints could be in any appropriate form including the lengths of edges connecting two vertices, parallelism, perpendicularity, angles, etc.

The 3D reconstruction problem to be solved may be understood as follows. For a 3D solid having n vertices to be reconstructed, with lᵢⱼ being the length of edge ij in 3D space (which edge can be either real or imaginary), Equation (5) gives:

$$\{ \begin{matrix}{x}_{i}^{′} = {x}_{i} - \frac{α}{γ} {z}_{i} \\ {y}_{i}^{′} = {y}_{i} - \frac{β}{γ} {z}_{i} \\ {x}_{j}^{′} = {x}_{j} - \frac{α}{γ} {z}_{j} \\ {y}_{j}^{′} = {y}_{j} - \frac{β}{γ} {z}_{j} \\ {( {x}_{i} - {x}_{j} )}^{2} + {( {y}_{i} - {y}_{j} )}^{2} + {( {z}_{i} - {z}_{j} )}^{2} = {l}_{ij}^{2}\end{matrix} \\ i , j = 1 , 2 , … , n and i \neq j \qquad ( 6 )$$

Defining:

$$\{ \begin{matrix}Δ {x}_{ij}^{′} = {x}_{i}^{′} - {x}_{j}^{′} \\ Δ {y}_{ij}^{′} = {y}_{i}^{′} - {y}_{j}^{′} \\ Δ {z}_{ij} = {z}_{i} - {z}_{j}\end{matrix} \\ i , j = 1 , 2 , … , n and i \neq j \qquad ( 7 )$$

allows Equation (6) to be rewritten as:

$${[ Δ {x}_{ij}^{′} + \frac{α}{γ} Δ {z}_{ij} ]}^{2} + {[ Δ {y}_{ij}^{′} + \frac{β}{γ} Δ {z}_{ij} ]}^{2} + Δ {z}_{ij}^{2} = {( {l}_{ij} )}^{2} \\ i , j = 1 , 2 , … , n and i \neq j \qquad ( 8 )$$

Since the projection vector has a unit length, i.e. α²+β²+γ²=1 as shown in equation (1), Equation (8) may be further simplified to:

(Δzᵢⱼ)²+2γ(αΔx′ᵢⱼ+βΔy′ᵢⱼ)Δzᵢⱼ+γ²[(Δx′ᵢⱼ)²−(lᵢⱼ)²]=0 (9)

and therefore:

$$Δ {z}_{ij} = γ ⌊ \begin{matrix}- ( α {Δ}_{ij}^{′} + β Δ {y}_{ij}^{′} ) \pm \\ \sqrt{{( αΔ {x}_{ij}^{′} + βΔ {y}_{ij}^{′} )}^{2} - [ {( Δ {x}_{ij}^{′} )}^{2} + {( Δ {y}_{ij}^{′} )}^{2} - {( {l}_{ij} )}^{2}}\end{matrix} ⌋ \qquad ( 10 )$$

There are two possible cases for Equation (10):

$$\begin{matrix}Δ {z}_{ij} = {ζ}_{ij}^{1} , where & ( 11 ) \\ {ζ}_{ij}^{1} = γ ⌊ \begin{matrix}- ( α Δ {x}_{ij}^{′} + β Δ {y}_{ij}^{′} ) + \\ \sqrt{{( αΔ {x}_{ij}^{′} + βΔ {y}_{ij}^{′} )}^{2} - [ {( Δ {x}_{ij}^{′} )}^{2} + {( Δ {y}_{ij}^{′} )}^{2} - {( {l}_{ij} )}^{2} ]}\end{matrix} ⌋ \\ or & ( 12 ) \\ Δ {z}_{ij} = {ζ}_{ij}^{2} , where & ( 13 ) \\ {Δζ}_{ij}^{2} = γ ⌊ \begin{matrix}- ( α {Δx}_{ij}^{′} + β Δ {y}_{ij}^{′} ) - \\ \sqrt{{( αΔ {x}_{ij}^{′} + βΔ {y}_{ij}^{′} )}^{2} - [ {( Δ {x}_{ij}^{′} )}^{2} + {( Δ {y}_{ij}^{′} )}^{2} - {( {l}_{ij} )}^{2} ]}\end{matrix} ⌋ & ( 14 )\end{matrix}$$

Thus, for n vertices to be reconstructed there are n equations as follows:

$$\{ \begin{matrix}{z}_{1} - {z}_{2} = {ζ}_{12}^{{k}_{1}} \\ {z}_{2} - {z}_{3} = {ζ}_{23}^{{k}_{2}} \\ … \\ {z}_{n - 1} - {z}_{n} = {ζ}_{n - 1 , n}^{{k}_{n - 1}} \\ {z}_{n} - {z}_{1} = {ζ}_{n 1}^{{k}_{n}}\end{matrix} \\ {k}_{i} = 1 or 2 \qquad ( 15 )$$

The following useful observations may be made regarding Equation (15):
1. the n equations are linearly dependent, since

ζ₁₂^{k}^{₁}+ζ₂₃^{k}^{₂}+ . . . +ζ_{n-1,n}^{k}^{ₙ₋₁}+ζₙ₁^{k}^{ₙ}=0, kᵢ=1 or 2 (16)

and, therefore, the z value of one vertex has to be preset or predefined; and
2. Equation (15) implies that there are 2n sets of possible equations, since the value of kᵢ can be either 1 or 2. However, only n sets out of them are valid. To support the solution of the above equations, a user input is needed to determine which of the two values of ζᵢⱼ^{k}^{ᵢ} will be used in Equation (15). This is achieved by having the user indicate the relative depth of vertices. The two values of ζᵢⱼ^{k}^{ᵢ} result as there are two solutions to the quadratic equation (8).

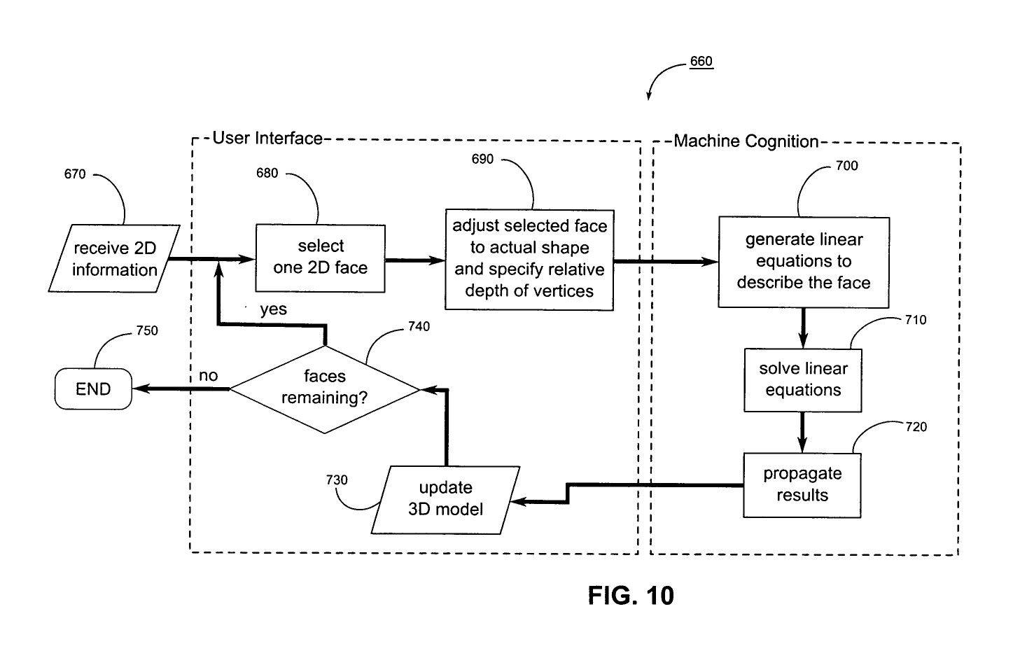

In view of the foregoing, the interactive linear formulation component 390 carries out the interactive linear formulation reconstruction method 660 illustrated in FIG. 10 in order to obtain the needed constraints, as described above, from a user. As with the interactive constraint application component 380, the system receives the 2D information (step 670) comprising elements of the 2D line drawing (e.g. lines, vertices, etc.) as well as the boundary edge loops previously validated as representing faces by the interactive face identification module 70. The 2D information may be the same as described above as being received by the interactive constraint application component 380 or may be a subset thereof (e.g. a portion of the 2D line drawing consisting only of straight lines), the latter being advantageous especially when the two components are used in conjunction. The two components may be used in conjunction, for example, whereby the interactive linear formulation component 390 processes the portion of the 2D line drawing consisting of straight lines only while the interactive constraint application component 380 process the remainder of the 2D line drawing.

The system proceeds by iteratively receiving shape correction and relative depth constraints from the user for each validated face of the 2D line drawing. The system presents the 2D line drawing with validated faces to the user. In each iteration the user selects one 2D face (step 680), adjusts and corrects the shape of the face (e.g. by moving the endpoints of the edges), if desired, and specifies the relative depth of the vertices (step 690). The system then generates, from this information provided by the user, a set of linear equations to describe the corresponding face (step 700), and solves the linear equations (step 710) as described above for the 3D depth information of the face including the corresponding vertices. As described above in connection with the interactive constraint application component, on each occasion that fresh 3D information is determined for any part of the 2D drawing such information is propagated to the remaining elements to determine further 3D information prior to receiving further constraints from the user (step 720). The 3D model is then updated accordingly (step 730) and, if further faces remain for the user to adjust and provide relative depth information (decision 740) then the process repeats for the next such face. Otherwise, the method ends (step 750).

### CONCLUSION

Thus, the system and method as described hereinabove advantageously and effectively reconstructs a 3D solid model from a 2D axonometric projection by providing a convenient means for a user to input such further information in the form of constraints as is necessary for carrying out the reconstruction.

It will be understood by skilled artisans that the systems and methods described herein may selectively incorporate any features known in the art to facilitate or enhance user interaction with the system. Such features may include undo/redo functions to recover from errors, or functions to provide desired display modalities (e.g. whereby the 3D model is displayed as a 3D shaded model, or whereby the interface provides means to zoom, pan or rotate a displayed 3D model).

Embodiments of the above-described system and method may be implemented in any conventional computer programming language. For example, preferred embodiments may be implemented in a procedural programming language (e.g. “C”) or an object oriented language (e.g. “C++”). Alternative embodiments of the invention may be implemented as pre-programmed hardware elements, other related components, or as a combination of hardware and software components.

Embodiments of the system and method can be implemented as a computer program product for use with a computer system. Such implementation may include a computer data signal representing sequences of statements and instructions which, when executed by a processor, cause the processor to carry out any of the above-described methods and functions. Such a computer signal may be fixed either on a tangible medium, such as a computer readable medium (e.g., a diskette, CD-ROM, ROM, or fixed disk) or transmittable as a carrier wave to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The sequence of computer instructions embodies all or part of the functionality previously described herein.

Skilled artisans will appreciate that computer instructions embodying the systems or methods described hereinabove can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

It is expected that a computer program product embodying the systems and methods described hereinabove may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web). Of course, some embodiments of the system and method may be implemented as a combination of both software (e.g., a computer program product) and hardware. Still other embodiments of the system and method may be implemented as entirely hardware (e.g. a dedicated printed circuit board), or entirely software (e.g., a computer program product).

Embodiments of the systems and methods described hereinabove can also be implemented in a method for enabling a computer to reconstruct a 3D solid model from a 2D axonometric projection in the form of a 2D line drawing. In one embodiment, the method comprises the step of transmitting computer-readable program code to a computer. In another embodiment, the method comprises the step of making available for receipt by a computer the computer-readable program code. The computer-readable program code contains software instructions for configuring the computer in accordance with any of the above-described systems, or for enabling the computer to perform predetermined operations including the steps of any of the above-described methods.

With the foregoing exemplary embodiments having been disclosed, it will be apparent to those skilled in the art that various changes and modifications can be made to appropriately suit the needs and objectives of another application and still achieve the advantages of the invention; all such changes and modifications are intended to fall within the scope of the invention as defined by the claims that follow.

What is claimed is:

1. A method of reconstructing a 3D solid model from a 2D line drawing, the 3D solid model comprising a plurality of elements including a plurality of faces, the method comprising the steps of:
(a) interactively determining a plurality of boundary edge loops in the 2D line drawing wherein each boundary edge loop is a 2D projection of a corresponding one of the faces in the 3D solid model; and
(b) interactively determining 3D information of the elements of the 3D solid model from the boundary edge loops and a plurality of user-supplied constraints
wherein the 3D solid model is reconstructed by the determination of the 3D information of the elements of the 3D solid model.

2. The method of claim 1 wherein step (a) comprises the steps of:
(a1) determining a plurality of candidate boundary edge loops in the 2D line drawing, the candidate boundary edge loops being at least as many as the boundary edge loops; and
(a2) interactively receiving user input for selectively identifying each candidate boundary edge loop as a corresponding one of the boundary edge loops in the 2D line drawing.

3. The method of claim 2 wherein step (a1) comprises the steps of:
(a11) identifying minimal potential loops, each having a potential to be one of the faces, by using a depth-first search process; and
(a12) determining a maximal clique of the minimal potential loops identified in step (a11), thereby determining the plurality of candidate boundary edge loops.

4. The method of claim 3 wherein step (a2) comprises the steps of:
(a21) displaying the plurality of candidate boundary edge loops; and
(a22) receiving user input for selectively identifying all of the candidate boundary edge loops displayed in step (a21) as corresponding boundary edge loops.

5. The method of claim 3 wherein step (a2) comprises the steps of, iteratively:
(a21) displaying one of the candidate boundary edge loops wherein a different one of the candidate boundary edge loops is displayed in each iteration; and
(a22) receiving user input for selectively identifying the candidate boundary edge loop displayed in step (a21) as a corresponding one of the boundary edge loops
until all of the candidate boundary edge loops have been displayed and any corresponding boundary edge loops have been selectively identified.

6. The method of claim 2 wherein step (b) comprises the steps of, iteratively:
(b1) receiving at least one of the user-supplied constraints;
(b2) selectively determining, from the user-supplied constraints received in step (b1), 3D information of at least one related element; and
(b3) propagating the 3D information of the at least one related element in step (b2) for determining 3D information of at least one further element in the 3D solid model
until all of the user-supplied constraints are received and any 3D information selectively determined therefrom is propagated.

7. The method of claim 6 wherein step (b2) comprises applying suitable logic which relates geometrical properties of the user-supplied constraints received in step (b1) and geometrical properties of the at least one related element to selectively determine the 3D information of the at least one related element.

8. The method of claim 6 wherein step (b2) comprises the steps of:
(b21) fixing a vertex corresponding to the user-supplied constraints received in step (b1);
(b22) constructing a constraint satisfaction problem comprising a mimimization problem of geometry of the user-supplied constraints received in step (b1); and
(b23) optimizing and solving the constraint satisfaction problem
wherein the at least one related element includes at least one additional vertex adjacent to the vertex fixed in step (b21); and
whereby the optimization and solution of the constraint satisfaction problem determines 3D information of the at least one additional vertex.

9. The method of claim 6 wherein step (b3) comprises the steps of:
(b31) determining a set of changed elements from a subset of the elements of the 3D solid model which had been previously changed and whose 3D information has not yet been propagated;
(b32) determining a set of candidate elements for propagation of the 3D information of the elements in the set of changed elements wherein each of the candidate elements is dependent upon an element in the set of changed elements;
(b33) ranking the elements in the set of candidate elements according to a predetermined set of ranking rules;
(b34) determining 3D information of a highest-ranked element in the set of candidate elements for which at least a portion of the 3D information is undetermined but is determinable from 3D information of elements in the 3D solid model upon which the highest-ranked element depends;
(b35) adding the element for which 3D information was determined in step (b34) and any other elements thereby changed to the set of changed elements;
(b36) repeating steps (b32) to (b35) until there remains no element in the set of candidate elements for which at least a portion of the 3D information is undetermined but is determinable from 3D information of elements in the 3D solid model upon which the element depends.

10. The method of claim 9 wherein the predetermined set of ranking rules in step (b33) determines a rank for each of the elements in the set of candidate elements according to predetermined priorities assigned by human cognition to geometrical characteristics including face planarity, skewed facial symmetry, line parallelism, line colinearity, line orthogonality, skewed face orthogonality, line verticality, isometry, minimum standard deviation of angles, corner orthogonality, face perpendicularity and symmetry.

11. The method of claim 2 wherein the 2D line drawing comprises a portion consisting of straight lines, and wherein step (b) comprises the steps of, iteratively for each of the boundary edge loops determined in step (a):
(b1) receiving user-supplied shape correction and relative depth constraints for vertices of the boundary edge loop;
(b2) generating a set of linear equations describing a corresponding one of the faces of the 3D solid model; and
(b3) solving the set of linear equations for 3D information of the vertices of the boundary edge loop.

12. The method of claim 6 wherein the 2D line drawing is: a 2D vertex-edge drawing corresponding to an isometric engineering drawing of a valid 3D object; or an axonometric projection of the 3D solid model.

13. The method of claim 6 wherein the elements of the 3D solid model include the vertices, straight edges, curved edges, the faces, planar faces, curved faces and the constraints.

14. The method of claim 6 wherein the 2D line drawing and the 3D solid model are represented in a single data structure wherein the 2D line drawing comprises a subset of the 3D solid model.

15. The method of claim 3 wherein, for the purposes of step (a11), each minimal potential loop is considered to have a potential to be one of the faces if it is a closed loop of non-self-intersecting edges wherein none of the edges connects two non-adjacent vertices in the closed loop.

16. The method of claim 6 wherein the plurality of candidate boundary edge loops includes a plurality of lists, each list containing at least one of the candidate boundary edge loops, wherein a first one of the lists contains fully visible candidate boundary edge loops and a second one of the lists contains occluded candidate boundary edge loops, and wherein step (a2) is carried out on the candidate boundary edge loops in the first one of the lists and then on the candidate boundary edge loops in the second one of the lists.

17. The method of claim 6 further comprising, prior to step (a1), the step of subdividing the 2D line drawing into a plurality of sub-regions, wherein steps (a1) and (a2) are first iteratively performed on each of the sub-regions and then on the entire 2D line drawing.

18. A computer program product for enabling a computer to reconstruct a 3D solid model from a 2D line drawing, the 3D solid model comprising a plurality of elements including a plurality of faces, the computer program product comprising a computer readable medium bearing software instructions for enabling the computer to perform the steps of:
(a) interactively determining a plurality of boundary edge loops in the 2D line drawing wherein each boundary edge loop is a 2D projection of a corresponding one of the faces in the 3D solid model; and
(b) interactively determining 3D information of the elements of the 3D solid model from the boundary edge loops and a plurality of user-supplied constraints
wherein the 3D solid model is reconstructed by the determination of the 3D information of the elements of the 3D solid model.

19. A method of enabling a computer to reconstruct a 3D solid model from a 2D line drawing, the 3D solid model comprising a plurality of elements including a plurality of faces, the method comprising the step of transmitting, to the computer, computer-readable program code for enabling the computer to perform the steps of:
(a) interactively determining a plurality of boundary edge loops in the 2D line drawing wherein each boundary edge loop is a 2D projection of a corresponding one of the faces in the 3D solid model; and
(b) interactively determining 3D information of the elements of the 3D solid model from the boundary edge loops and a plurality of user-supplied constraints
wherein the 3D solid model is reconstructed by the determination of the 3D information of the elements of the 3D solid model.

20. The method of claim 19 wherein the step of transmitting comprises the step of creating in a transmission medium a computer data signal embodying the computer-readable program code.
